(19) United States
(12) Patent Application Publication
(10) Pub. No.: US 2012/0080983 A1
(43) Pub. Date: Apr. 5, 2012

(54) STATOR WITH COOLING SYSTEM AND ASSOCIATED MOTOR

(76) Inventor: Trevor Iund, Peoria, IL (US)

(21) Appl. No.: 12/898,237

(22) Filed: Oct. 5, 2010

(51) Int. Cl. H02K 1/20

(52) U.S. Cl. 310/60 A

(57) ABSTRACT

An electric motor is disclosed that includes a rotor having an axis and being rotatable about the axis. A stator is positioned about the rotor and includes a plurality of laminates with each laminate in the plurality of laminates including a peripheral edge defining a notch. The plurality of laminates includes a plurality of laminate subsets, with the laminates in each laminate subset arranged with the notches aligned to define a passage. The laminate subsets are arranged such that the passages defined by the laminate subsets form a substantially helical channel along the periphery of the stator.

### TECHNICAL FIELD

The present disclosure relates generally to a cooling system for an electrical motor. More particularly, the disclosure relates to a cooling system for a stator of an electrical motor.

### BACKGROUND

For electric motors or generators, particularly those used in stationary applications, reasonable cooling is accomplished by using air cooling and motor housings that serve as heat sinks. Traction motors are typically forced-air cooled with a blower. Ducting is used to route air into and out of the motor or generator. However, in certain applications, air cooling is not practical on account of the blower and ducting requirements.

Air cooling is often considered inadequate, particularly for electric motors on powerful automobiles or machines that are subject to varied temperature ranges and environments. The air for cooling may be dusty or dirty or the electric motors themselves may become coated with mud and dust, reducing the ability to cool the electric motors with air. In order to maintain cooling uniformity in diverse environments, electric motors using liquid cooling have been developed. In such motors, oil or water systems that already exist on the vehicle may be used to facilitate cooling.

Although liquid cooling enables the use of fluids readily available on the vehicle and is exceedingly effective in cooling electric motors, it is a much more expensive and complex way of cooling. The complexity associated with liquid cooling is generally on account of the routing of the coolant through and over the electric motors or generators to achieve adequate cooling.

U.S. Patent Application Publication No. 2008/0100159 A1 to Dawsey et al. describes a cooling system comprising a coaxial stack of laminates with each identical laminate directly abutting the adjacent laminate. The peripheral edge of each laminate is provided with multiple projecting pins. The projecting pins cooperate with a jacket surrounding the stator to provide a cooling space through which the cooling fluid flows. The pins of adjacent laminates are misaligned to form channels through which the cooling fluid may flow. Though the misaligned pins generate turbulence and may enable the cooling fluid to reach a greater area, they may overly reduce the flow of the cooling fluid over the electric motors or generators, causing inefficiency. Accordingly, there is a requirement for a cooling system for electric devices that is efficient, cost effective and less complex.

### SUMMARY OF THE INVENTION

A stator of an electric motor is disclosed that includes a plurality of laminates, each laminate in the plurality of laminates including a peripheral edge defining a notch. The plurality of laminates are arranged such that the notches form a substantially helical channel along a periphery of the stator.

A stator of an electric motor is disclosed that includes a plurality of laminates including a plurality of laminate subsets. The laminates in each laminate subset are arranged with the notches aligned to define a passage. The laminate subsets are arranged such that the passages defined by the laminate subsets form a substantially helical channel along the periphery of the stator.

An electric motor is disclosed that includes a rotor having an axis and being rotatable about the axis. A stator is positioned about the rotor and includes a plurality of laminates with each laminate in the plurality of laminates including a peripheral edge defining a notch. The plurality of laminates includes a plurality of laminate subsets, with the laminates in each laminate subset arranged with the notches aligned to define a passage. The laminate subsets are arranged such that the passages defined by the laminate subsets form a substantially helical channel along the periphery of the stator.

### BRIEF DESCRIPTION OF THE DRAWINGS

FIG. 1 is a schematic diagram of an exemplary power system employing an electric motor.

FIG. 2 is a cross-sectional view of an electric motor along line 2-2 of FIG. 1 in accordance with an embodiment of the invention.

FIG. 3 is an isometric view of a laminate used to form a stator in accordance with an embodiment of the invention.

FIG. 4 is an isometric view of a stator defining a substantially helical channel in accordance with a first embodiment of the invention.

FIG. 5 is an isometric view of a stator defining a substantially helical channel in accordance with a second embodiment of the invention.

FIG. 6 is an isometric view of a stator defining a substantially helical channel in accordance with a third embodiment of the invention.

FIG. 7 is an isometric view of a stator defining a substantially helical channel in accordance with a fourth embodiment of the invention.

### DETAILED DESCRIPTION

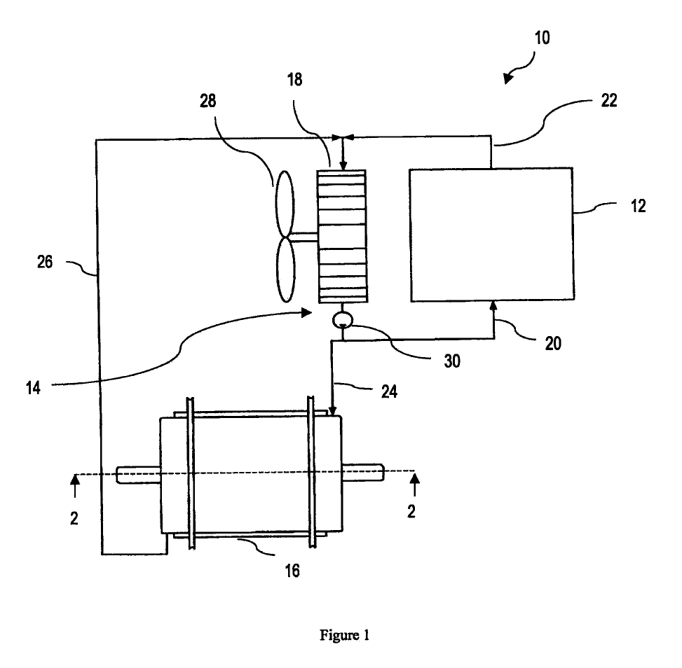

FIG. 1 is a schematic diagram of a power system 10 requiring an electric motor 16. The power system 10 includes a power source 12, a cooling system 14 and an electric motor 16. The power system 10 may be used in various applications including a mobile application, such as on a work machine or other vehicles. The power source 12 generates power for the electric motor 16 to run. The power source 12 may include any known source of power including an internal combustion engine such as, for example, a diesel engine or a gasoline engine. The power source 12 may also include alternative sources of power such as a battery, a furnace or such other power sources known in the art.

The cooling system 14 is configured to circulate a heat-transferring medium (not shown) and keep the electric motor 16 and/or the power source 12 from overheating. The heat-transferring medium may be a low or high pressure fluid. Low-pressure fluids may include, by way of example, water and oils such as engine oil, brake oil, or any other low-pressure fluid known for transferring heat. High-pressure fluids may include by way of example, nitrogen, helium or other high-pressure fluids known for transferring heat. The cooling system 14 may comprise a heat exchanger 18, a fan 28, and a source 30 of the heat transferring medium.

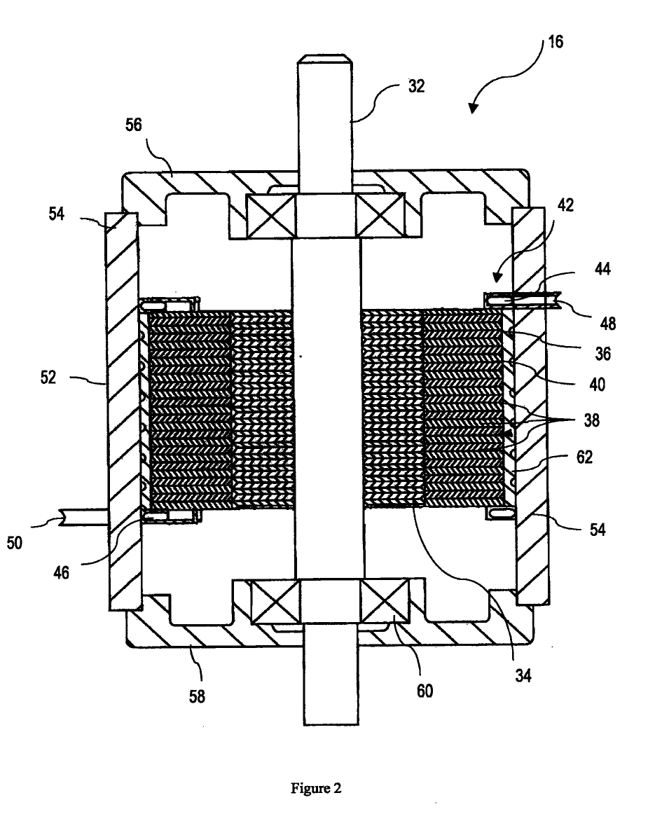

In the embodiment illustrated in FIG. 1, the heat exchanger 18 is connected to a cooling assembly 42 (illustrated in FIG. 2) of the electric motor 16 by a supply conduit 24 and a return conduit 26 and is connected to the power source 12 by a supply conduit 20 and a return conduit 22. By way of example, the heat exchanger 18 may function as the main radiator of the vehicle, with the heat transferring medium transferring heat to air flowing over the radiator. The fan 28 may be positioned proximate the heat exchanger 18 to produce a flow of air across heat exchanger 18. The fan 28 may be omitted if not required, and a secondary fluid circuit (not shown) may be connected to the heat exchanger 18 to transfer heat from the heat transferring medium. The source 30 of the heat transferring medium may include any device for pressurizing the heat transferring medium within the cooling system 14. By way of example, the source 30 may be a pump (not shown) driven by the power source 12.

FIG. 2 is a cross-sectional view of the electric motor 16 along line 2-2 of FIG. 1. The electric motor 16 includes a shaft 32, a rotor 34, a stator 36, a cooling assembly 42, and a housing 52.

The shaft 32 of the electric motor 16 may be a cylindrical component or may be configured to any other shape known in the art. The shaft 32 transmits power into and/or out of electric motor 16 and may be connected to housing 52 by means of one or more bearings 60. The shaft 32 may extend beyond the housing 52 from one or both ends of the housing 52. Alternatively, multiple shafts (not shown) may be incorporated within the electric motor 16.

The shaft 32 is fixed to the rotor 34 so that as the shaft 32 rotates, it drives the rotor 34. Rotor 34 may include a stack of laminates (not shown). The stack of laminates may be fastened to shaft 32 by welding, by threaded fastening or by other methods known in the art. The rotor 34 is housed within the stator 36 and is configured to rotate within the stator 36 to create torque. Stator 36 includes a stack of laminates 38, each laminate 38 having a peripheral edge 16. The windings (not shown) formed of conducting material are arranged along the periphery of the stator 36.

Still looking at FIG. 2, the cooling assembly 42 includes a cooling jacket 62, with the stator 36 positioned within the cooling jacket 62. The housing 52 includes a shell 54, a first end cap 56, and a second end cap 58. The shell 54 surrounds shaft 32, rotor 34, stator 36, and the cooling jacket 62. In the embodiment illustrated in FIG. 2, the first and second end caps 56 and 58 each contain a centrally positioned through-hole that facilitates the extension of the shaft 32 through the housing 52.

The cooling jacket 62 may be a cylindrical housing for the stator 36 and is deployed to transfer heat to and from the stator 36. The cooling jacket 62 and the periphery of the stator 36 define channels in fluid communication with the cooling system 14. The cooling jacket 62 may comprise an inlet manifold 44 and an outlet manifold 46. The inlet manifold 44 of the cooling jacket 62 is connected to an inlet port 48 of the housing 52 and the outlet manifold 46 of the cooling jacket 62 is connected to an outlet port 50 of the housing 52. The inlet port 48 of the housing 52 is connected to supply conduit 24 of the cooling system 14 and the outlet port 50 of the housing 52 is connected to the return conduit 26 of the cooling system 14.

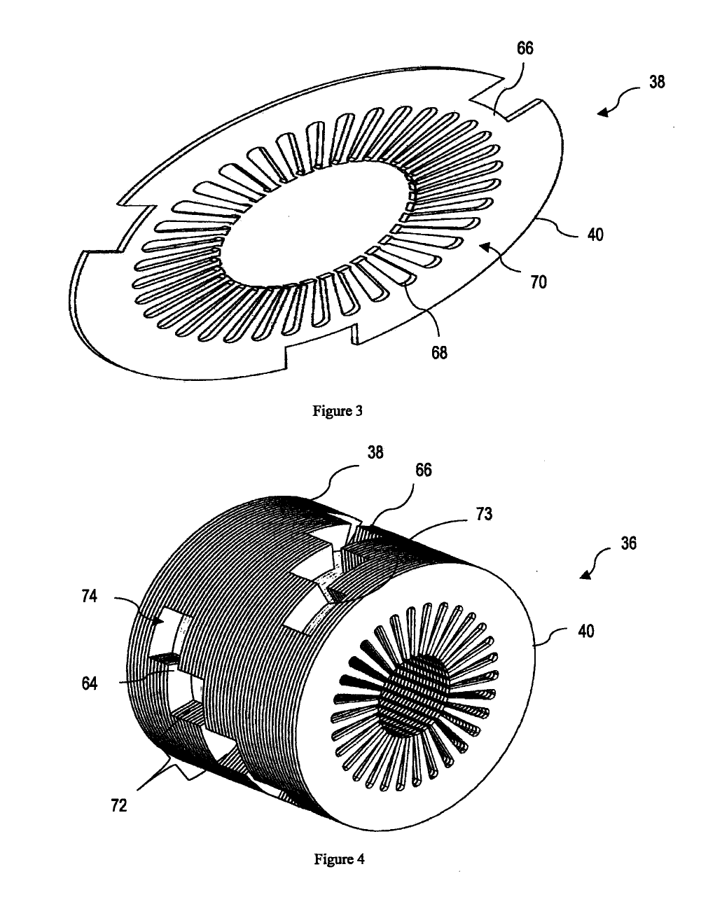

FIG. 3 is an isometric view of one of the individual laminates 38 of the plurality of laminates that forms the stator 36. Each laminate 38 of the plurality of laminates has a peripheral edge 40 defining a notch 66. In the embodiment illustrated, the laminate 38 is shown to have a plurality of uniformly distributed notches 66. The dimensions of the notch 66 including the depth and the width of the notch 66 formed on the laminate 38 may be determined by the oil flow rate and the surface area of the stator 36 that is to be cooled. The dimensions of the notches 66 may also depend on the dimensions of the stator 36, including thickness of the laminates 38 and the stator area required to restrain the stator 36 from rotating in the cooling jacket 62 or housing 52.

The notches 66 may be arcuate, rectangular, triangular or other known shapes. The number of notches 66 on the laminate 38 may also be determined by the oil flow rate and the surface area of the stator 36 that is to be cooled.

Each laminate 38 also has a plurality of teeth 70 formed on its inner edge 68 and windings (not shown) may be configured at both edges of the laminates 38. The laminates 38 may be made of steel or any other material suitable for forming stators.

The laminates 38 may be substantially identical such that each has a notch 66 of the same dimensions. Alternatively, some laminates 38 may have notches 66 sized differently from other laminates 38. The laminates 38 with differently sized notches 66 may be used as transition laminates 64 between laminates 38 having similar sized notches 66.

FIG. 4 is an isometric view of a stator 36 defining a substantially helical channel 74 in accordance with a first embodiment of the invention. The laminates 38 are arranged such that the notches 66 form a substantially helical channel 74 on the outer periphery of the stator 36. In the embodiment illustrated, each laminate 38 has a plurality of notches 66 that are uniformly distributed along its peripheral edge 16, the plurality of notches 66 forming a plurality of channels along the periphery of the stator 36. Also in the embodiment illustrated, the plurality of laminates 38 includes a plurality of laminate subsets 72, wherein the laminates 38 in each laminate subset 72 are arranged with the notches 66 aligned to define a passage 73. The laminate subsets 72 are arranged such that the passages 73 defined by the laminate subsets 72 form a substantially helical channel 74 along the periphery of the stator 36.

In the embodiment illustrated, each of the laminate subsets 72 is separated from one or two adjacent laminate subsets 72 by a plurality of transition laminates 64 to form the substantially helical channel 74. The notch 66 defined by each of the transition laminates 64 is larger in width than the passages 73 formed by each of the laminate subsets 72. In the embodiment illustrated, the notches 66 of the plurality of transition laminates 64 are aligned.

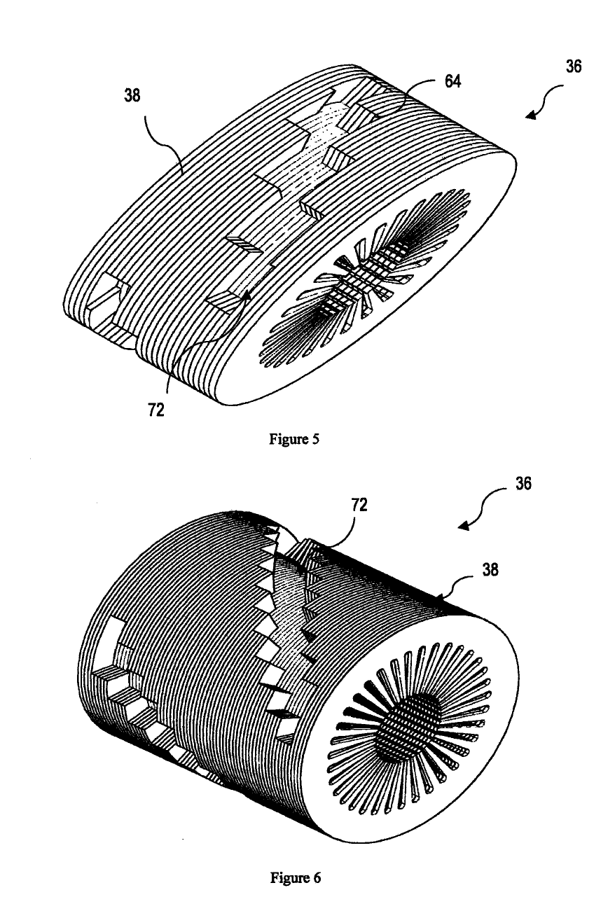

FIG. 5 is an isometric view of a stator 36 defining a substantially helical channel 74 in accordance with a second embodiment of the invention. In the embodiment illustrated in FIG. 5, the notch 66 defined by each of the transition laminates 64 is smaller in width than the passages 73 formed by each of the laminate subsets 72.

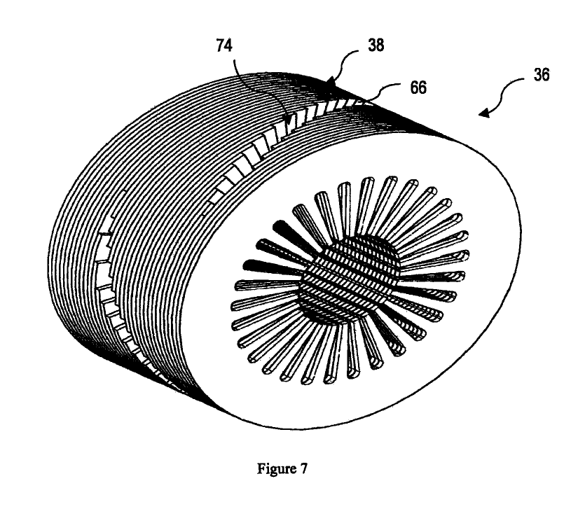

FIG. 6 is an isometric view of a stator 36 defining a substantially helical channel 74 in accordance with a third embodiment of the invention. In the embodiment illustrated in FIG. 6, the notches 66 defined by each of the plurality of laminates are substantially identical and the plurality of laminates 38 include laminate subsets 72. The laminate subsets 72 are stacked one on top of the other without any transition laminate to form a substantially helical channel 74.

FIG. 7 is an isometric view of a stator 36 defining a substantially helical channel 74 in accordance with a fourth embodiment of the invention. The laminates 38 of the plurality of laminates are arranged without forming laminate subsets. The notch 66 defined by each laminate 38, is offset from the notch 66 defined by the adjacent laminate 38 to form a substantially helical channel 74 along the periphery of the stator 36. In the embodiment illustrated, the laminates 38 are identical with a single notch 66 of the same dimension.

Various forms of the channel may be formed by different arrangement of the laminates 38. By way of example, in the fourth embodiment described above, each laminate 38 may be separated from a subsequent laminate 38 by a transition laminate 64 having a notch 66 with different dimensions. The laminates 38 may be arranged such that the notches 66 form a plurality of substantially helical channels 74 along the periphery of the stator 36. The plurality of substantially helical channels 74 may extend in the same direction or may extend in different directions. Similarly, the plurality of substantially helical channels 74 formed on the periphery of the stator 36 may have the same angle or may have different angles. The laminates 38 may also be arranged such that the plurality of channels may or may not be in fluid communication with each other.

### INDUSTRIAL APPLICABILITY

The substantially helical channel 74 formed on the periphery of the stator 36 and surrounded by the cooling jacket 62 provides a path for the flow of the heat transferring medium. The heat transferring medium enters the stator 36 from the inlet manifold 44 via inlet port 48, and leaves the stator 36 through the outlet manifold 46 via outlet port 50. The heat transferring medium is returned to the heat exchanger 18 which removes the heat from the heat transferring medium. The supply conduit 24 of the heat exchanger 18 returns the heat transferring medium to the inlet manifold 44 of the stator 36 of the electric motor 16 to provide continuous and circulated cooling.

Alternatively, the laminates 38 may be arranged such that some of the heat transferring medium is directed back along the substantially helical channels 74 of the stator 36.

For laminates 38 having a plurality of notches 66 and consequently defining a plurality of substantially helical channels 74 along the periphery of the stator 36, multiple inlet manifolds 44 may be provided, each inlet manifold 44 in fluid communication with the inlet port 48. Similarly, multiple outlet manifolds 46 may be provided, each outlet manifold 46 in fluid communication with the outlet port 50. Each inlet manifold 44 will supply the heat transferring medium for flow through its respective channel from the inlet port 48 and each outlet manifold 46 will direct the heat transferring medium to the outlet port 50.

The substantially helical channels 74 generate a swirl of the heat transferring medium around the stator 36, as opposed to travel in straight or wavy paths. Travel of the heat transferring medium in a substantially helical manner around the stator 36 generates turbulence in the heat transferring medium without obstructing the flow of the heat transferring medium. The substantially helical channels 74 of the cooling system 14 also increase the cooling efficiency of the electric motor 16 without increasing its size or weight. Such benefits may transform into higher specific power, and/or lower manufacturing costs for electric machines, as well as other devices using above-described cooling systems 14.

The cooling system 14 as described may be used with any electric motor 16 or generator as well as other electrical devices such as transformers. Such electric devices may also be used in any environment including in particular for cooling electric motors 16 used on mobile vehicles or work machines.

It will be apparent to those skilled in the art that various modifications and variations can be made in the disclosed system without departing from the scope of the invention. Other embodiments of the stator will be apparent to those skilled in the art from consideration of the specification. It is intended that the specification and examples be considered as exemplary only, with a true scope of the invention being indicated by the following claims and their equivalents.

What is claimed is:

1. A stator of an electric motor, comprising:
a plurality of laminates, wherein each laminate in the plurality of laminates includes a peripheral edge defining a notch, and the plurality of laminates are arranged such that the notches form a substantially helical channel along a periphery of the stator.

2. A stator as claimed in claim 1, wherein the laminates are substantially identical.

3. A stator as claimed in claim 1, wherein the plurality of laminates includes a first laminate, a second laminate and a transition laminate, the first and second laminates separated from one another by the transition laminate.

4. A stator as claimed in claim 3, wherein the dimensions of the notch defined by the transition laminate are different from the dimensions of the notches defined by the first and second laminates.

5. A stator as claimed in claim 1, wherein the plurality of laminates are arranged such that the notches defined by the plurality of laminates form a plurality of substantially helical channels along the periphery of the stator.

6. The stator of claim 1, wherein the plurality of laminates includes a laminate subset that includes a plurality of the laminates with the edges of their notches aligned.

7. A stator of an electric motor, comprising:
a plurality of laminates, wherein each laminate in the plurality of laminates includes a peripheral edge defining a notch;
the plurality of laminates including a plurality of laminate subsets, the notches defined by the laminates in each laminate subset being aligned to define a passage, the laminate subsets being arranged such that the passages defined by the laminate subsets form a substantially helical channel along the periphery of the stator.

8. A stator as claimed in claim 7, wherein a transition laminate in the plurality of laminates separates adjacent laminate subsets from one another.

9. A stator as claimed in claim 7, wherein the passages defined by the laminate subsets form a plurality of substantially helical channels along the periphery of the stator.

10. A stator as claimed in claim 9, wherein adjacent channels in the plurality of helical channels are separated from one another by a transition laminate.

11. The stator according to claim 7, wherein each laminate in the plurality of laminates includes a plurality of notches distributed around its peripheral edge.

12. The stator of claim 11, wherein the notches of the plurality of laminates form a plurality of substantially helical channels around the periphery of the stator.

13. The stator of claim 11, wherein the plurality of notches in each of the plurality of laminates are uniformly distributed around the peripheral edge of each of the laminates.

14. An electric motor, comprising:
a rotor having an axis and being rotatable about the axis;
a stator positioned about the rotor and including a plurality of laminates; wherein each laminate in the plurality of laminates includes a peripheral edge defining a notch;
the plurality of laminates including a plurality of laminate subsets, the notches defined by the laminates in each laminate subset being aligned to define a passage, the laminate subsets being arranged such that the passages defined by the laminate subsets form at least one substantially helical channel along the periphery of the stator.

15. The electric motor of claim 14, wherein:
the plurality of laminate subsets includes a first laminate subset and a second laminate subset disposed adjacent the first laminate subset; and
wherein the notches in the second laminate subset have a different size than the notches in the first laminate subset.

16. The electric motor of claim 15, wherein the notches in the second laminar subset are larger in width than the notches in the first laminar subset.

17. The electric motor of claim 15, wherein an edge of one of the notches in the first laminate subset is substantially aligned with an edge of one of the notches in the second laminate subset.

18. The electric motor of claim 14, wherein the notches in the laminate subsets form a plurality of substantially helical channels along the periphery of the stator.

19. The electric motor of claim 14, wherein:
the plurality of laminate subsets includes a first laminate subset and a second laminate subset disposed adjacent the first laminate subset; and
wherein the notches in the second laminate subset have substantially the same size as the notches in the first laminate subset.

20. The electric motor of claim 19, wherein each of the edges of the notches in the first laminate subset are offset from each of the edges of the notches in the second laminate subset.
